(19) United States
(12) Patent Application Publication
(10) Pub. No.: US 2006/0226794 A1
(43) Pub. Date: Oct. 12, 2006

(54) Discharge lamp lighting apparatus and luminaire

(76) Inventors: Yuji Takahashi, Kanagawa-ken (JP); Go Kato, Kanagawa-ken (JP); Yanbin Sun, Kanagawa-ken (JP)

Correspondence Address: DLA PIPER RUDNICK GRAY CARY US LLP, P. O. BOX 9271, RESTON, VA, 20195, US

(21) Appl. No.: 11/388,198

(22) Filed: Mar. 24, 2006

(30) Foreign Application Priority Data
Mar. 24, 2005 (JP) P2005-085995
Jun. 24, 2005 (JP) P2005-184285
Jan. 26, 2006 (JP) P2006-017272

(51) Int. Cl. H05B 41/36; H05B 37/02

(52) U.S. Cl. 315/308; 315/209 R

(57) ABSTRACT

A discharge lamp lighting apparatus, comprises a DC power supply, an inverter circuit, connected to the DC power supply, and provided with at least two switching devices, and a discharge lamp energized by the inverter circuit, wherein one switching device has an on-duty complementarily different with an on-duty of the other switching device, and wherein the inverter circuit executes a switching operation in that the on-duty of the one switching device substitutes with the on-duty of the other switching device.

### CROSS-REFERENCE TO RELATED APPLICATION

This application is based upon and claims the benefit of priority from the prior Japanese Applications; No. 2005-85995 filed on Mar. 24, 2005, No. 2005-184285 filed on Jun. 24, 2005, and No. 2006-17272 filed on Jan. 26, 2006, the entire contents of that are incorporated herein by reference.

### BACKGROUND OF THE INVENTION

1. Field of the Invention

The present invention relates to a discharge lamp lighting apparatus provided with an inverter circuit having at least a pair of switching devices alternately turning on, and a luminaire equipping the discharge lamp lighting apparatus.

2. Description of the Related Art

As a prior art Japanese patent document; Tokkai-Hei 06-283286 discloses a technique for preventing straiation in discharge lamp by operating a pair of switching devices in a half bridge inverter circuit so as that they have on-duties asymmetric to each other. According to the patent document, it is described that a DC current flows through the discharge lamp by the on-duties asymmetric to each other, thereby, the straiation being suppressed in the degree that it is hardly recognized by human eye.

However, in the patent documents, since a DC current flows through a discharge lamp, there is a problem of occurrence of a so-called cataphoresis phenomenon.

### SUMMARY OF THE INVENTION

In order to achieve the above-mentioned object, an aspect of the discharge lamp lighting apparatus according to the present invention, comprises, a DC power supply, an inverter circuit, connected to the DC power supply, and provided with at least two switching devices, and a discharge lamp energized by the inverter circuit, wherein one switching device has an on-duty complementarily different with an on-duty of the other switching device, and wherein the inverter circuit executes a switching operation in that the on-duty of the one switching device substitutes with the on-duty of the other switching device.

### BRIEF DESCRIPTION OF THE DRAWINGS

FIG. 1 is a circuit diagram showing the whole of the first embodiment of the discharge lamp lighting apparatus according to the present invention;

FIG. 2 is a circuit diagram showing the details of the driving signal generating circuit in the first embodiment of the discharge lamp lighting apparatus according to the present invention;

FIGS. 3A to 3E are voltage wave form diagrams for explaining the process of forming the asymmetric driving signal with complementarily different on-duties in the first embodiment of the discharge lamp lighting apparatus according to the present invention.

FIG. 4A is a voltage wave form diagram for explaining the alternate asymmetric switching operation in the first embodiment of the discharge lamp lighting apparatus according to the present invention;

FIG. 4B is a current wave form diagram for explaining the alternate asymmetric switching operation in the first embodiment of the discharge lamp lighting apparatus according to the present invention;

FIG. 5A is a voltage wave form diagram for explaining the alternate asymmetric switching operation in the modification of the first embodiment of the discharge lamp lighting apparatus according to the present invention;

FIG. 5B is a current wave form diagram for explaining the alternate asymmetric switching operation in the modification of the first embodiment of the discharge lamp lighting apparatus according to the present invention;

FIG. 6 is a circuit diagram showing the whole of the second embodiment of the discharge lamp lighting apparatus according to the present invention;

FIG. 7 is a circuit diagram showing the whole of the third embodiment of the discharge lamp lighting apparatus according to the present invention;

FIG. 8 is a circuit diagram showing the whole of the fourth embodiment of the discharge lamp lighting apparatus according to the present invention;

FIG. 9 is a circuit diagram showing the whole of the fifth embodiment of the discharge lamp lighting apparatus according to the present invention;

FIG. 10 is a circuit diagram of the driving signal generating circuit in the sixth embodiment of the discharge lamp lighting apparatus according to the present invention;

FIG. 11A is a graph showing the change of the on-duty “a” in the sixth embodiment of the discharge lamp lighting apparatus according to the present invention;

FIG. 11B is a lamp current wave form in the sixth embodiment of the discharge lamp lighting apparatus according to the present invention;

FIG. 12A is a lamp current wave form of the discharge lamp lighting apparatus according to the present invention;

FIG. 12B is a lamp current wave form diagram in a conventional discharge lamp lighting apparatus;

FIG. 13A is a table showing the evaluation result of straiation restraining action in the discharge lamp lighting apparatus according to the present invention, in an ambient temperature of 25 degrees C.;

FIG. 13B is a table showing the evaluation result of straiation restraining function of the discharge lamp lighting apparatus according to the present invention in an ambient temperature of zero degree C.; and

FIG. 14 is a bottom view provided with the discharge lamp lighting apparatus characterized by the present invention showing the ceiling flush type luminaire according to the present invention.

### DETAILED DESCRIPTION OF THE INVENTION

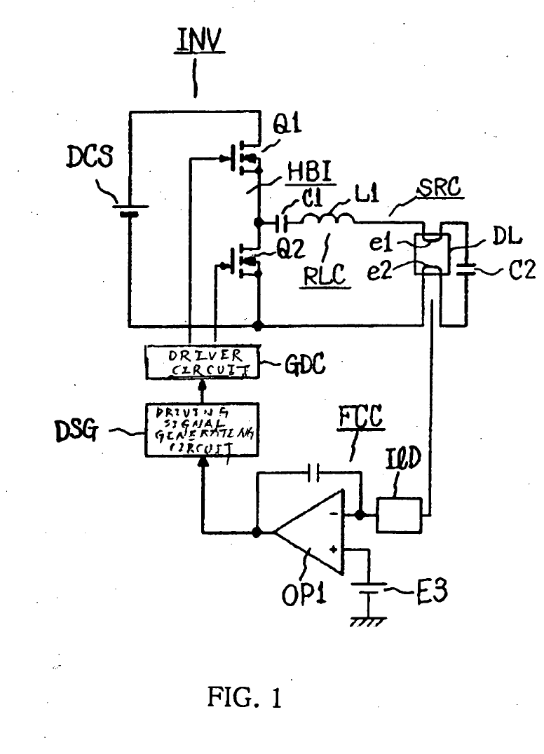

Referring now to the attached drawings, FIGS. 1 to 8, some embodiments of the present invention will be explained hereinafter.

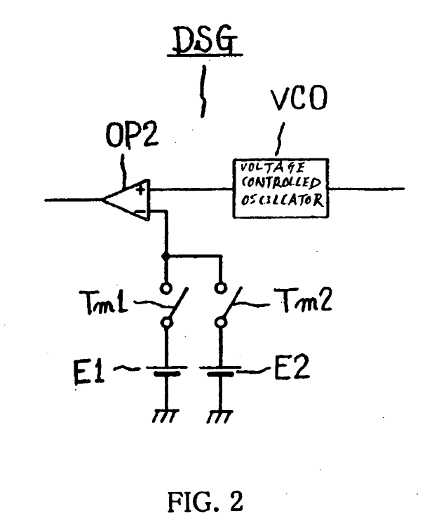

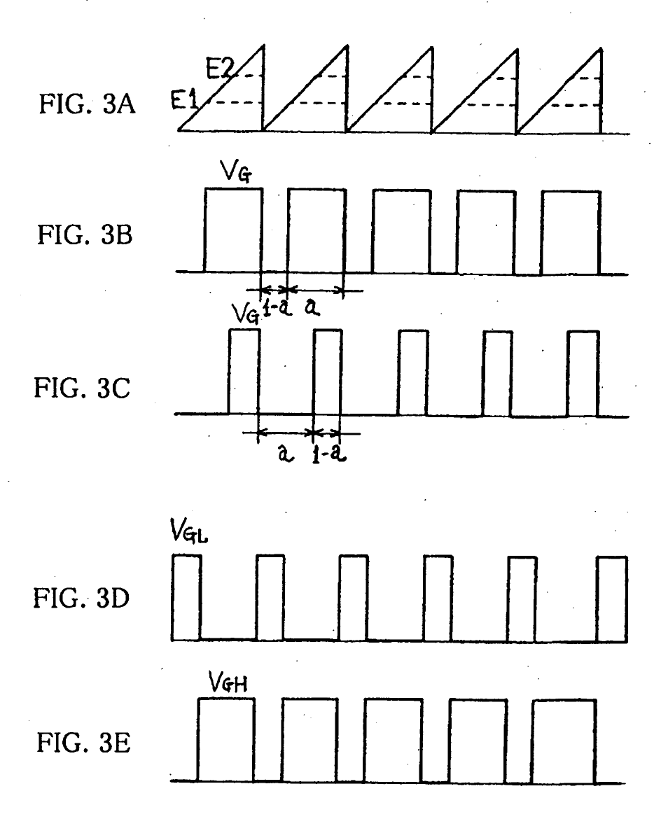

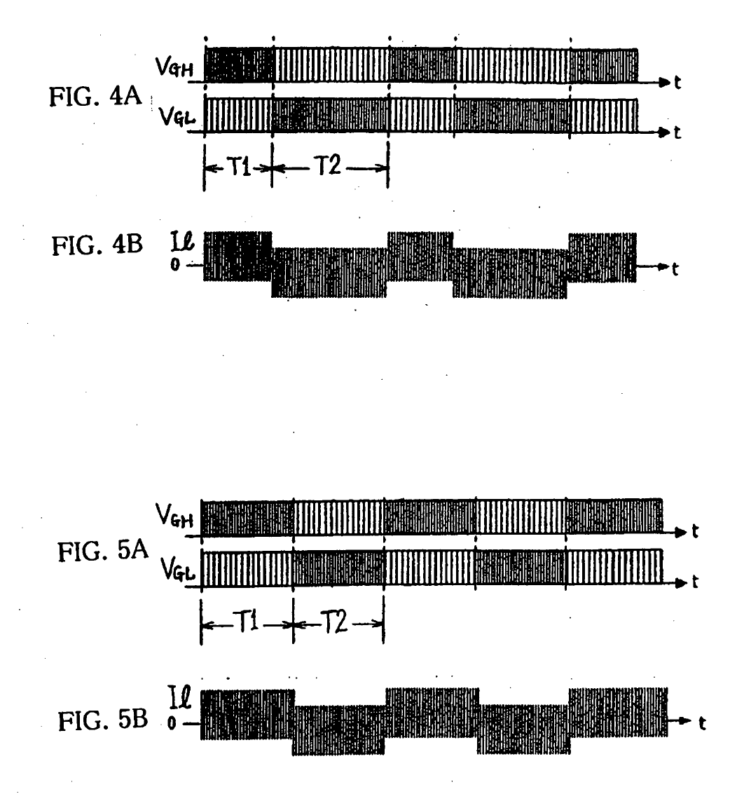

FIGS. 1 to 4 show the first embodiment of the discharge lamp lighting apparatus according to the present invention. FIG. 1 is a circuit diagram showing the whole of the first embodiment of the discharge lamp lighting apparatus. FIG. 2 is a circuit diagram showing the details of the driving signal generating circuit in the first embodiment of the discharge lamp lighting apparatus. FIGS. 3A to 3E are voltage wave form diagrams for explaining the process of forming the asymmetric driving signal with complementarily different on-duties in the first embodiment of the discharge lamp lighting apparatus. FIGS. 4A and 4B are a voltage wave form diagram and a current wave form diagram for explaining the alternate asymmetric switching operation in the first embodiment of the discharge lamp lighting apparatus.

In this embodiment, discharge lamp lighting apparatus is provided with a DC power supply DCS, an inverter circuit INV, a feedback control circuit FCC, a resonance load circuit RLC, and a discharge lamp DL.

Although details are omitted in the drawing, the DC power supply DCS rectifies a commercial AC power source voltage with a bridge rectifier circuit, and outputs a DC voltage that is obtained by smoothing the rectified voltage.

The inverter circuit INV is provided with a half bridge inverter HBI and a driving signal generating circuit DSG. The half bridge inverter HBI is provided with a pair of switching devices Q1 and Q2, and a drive circuit GDC. The pair of switching devices Q1 and Q2 are connected in series across the output electrodes of the DC power supply DCS.

The drive circuit GDC converts an original driving signal Vg1 or Vg2 controlled its on-duty as shown in FIGS. 3B or 3C, which is fed from the driving signal generating circuit DSG to asymmetrical waveform driving signals Vbh and Vgl, as shown in FIGS. 3D and 3E. The asymmetrical waveform driving signals Vbh and Vgl are then supplied to the switching devices Q1 and Q2 so as that the switching devices Q1 and Q2 alternately turn ON and OFF with each other.

The driving signal generating circuit DSG generates the original driving signal Vg1 and Vg2 which alternately turn ON for the first period T1 and the second period T2. The original driving signal Vg is then applied to the drive circuit GDC. In order to realize such operations, the driving signal generating circuit DSG is constituted as shown in FIG. 2. That is, the driving signal generating circuit DSG is provided with a voltage controlled oscillator VCO, a second differential amplifier OP2, first and second timer means Tm1 and Tm2 and, first and second reference potential sources E1 and E2. The voltage controlled oscillator VCO generates a saw-tooth wave form oscillation voltage whose frequency changes according to the feedback control signal from the feedback control circuit FCC as described later. The saw-tooth wave form oscillation voltage is then applied to a non-inverting input terminal of the second differential amplifier OP2 as described later. The differential amplifier OP2 compares the saw-tooth wave form voltage applied from the voltage controlled oscillator VCO with the first and the second reference potential sources E1 and E2. Then differences of the saw-tooth wave form voltage and the first and the second reference potential sources E1 and E2 are output from the second differential amplifier OP2. As shown in FIG. 4A, the first timer means Tm1 is kept in ON state, during the first period T1. After that, the first timer means Tm1 is turned off. As shown in FIG. 4A, further the second timer means Tm2 is turned ON following the first period T1, and kept in ON state for the second period T2. After that, the second timer means Tm2 is turned off. As shown in FIG. 3B, the first reference potential source E1 applies a reference potential corresponding to the on-duty “a” to the inverting input terminal of the second differential amplifier OP2. The second reference potential source E2 applies the reference potential corresponding to the on-duty “1-a” to the inverting input terminal of the second differential amplifier OP2 in FIG. 3C.

The feedback control circuit FCC generates a feedback signal by detecting a lamp current. The feedback signal is applied to the non-inverting input terminal of the second differential amplifier OP2 in the driving signal generating circuit DSG. In order to realize such operations, the driving signal generating circuit DSG is provided with a lamp current detecting circuit I1D, a first differential amplifier OP1, and a third reference potential source E3, as shown in FIG. 1. The lamp current detecting circuit I1D may be accomplished with any known lamp current detecting circuit. The first differential amplifier OP1 is applied an output of the lamp current detecting circuit I1D to its inverting input terminal, and the third reference potential source E3 with its non-inverting input terminal. The third reference potential source E3 supplies a reference potential, i.e., a control target potential.

The resonance load circuit RLC is provided with a DC blocking capacitor C1 and a series resonance circuit SRC. The DC blocking capacitor C1 is connected at its one terminal to a connection node of the switching devices Q1 and Q2, and at its other terminal to one terminal of the series resonance circuit SRC. The series resonance circuit SRC is a series circuit of an inductor L1 and a capacitor C2.

The discharge lamp DL is, for example, a fluorescent lamp. The capacitor C2 is then connected in series between a pair of filament electrodes e1 and e2 of such a fluorescent lamp.

Now the operation of the first embodiment of the discharge lamp lighting apparatus will be explained.

That is, the inverter circuit INV converts a DC voltage supplied from the DC power supply DCS to a high frequency AC voltage and outputs the high frequency AC voltage therefrom. The high frequency AC voltage is then applied to the resonance load circuit RLC. Accordingly, the pair of the filament electrodes e1 and e2 is preheated. A resonance voltage appearing across the capacitor C2 is applied to the pair of the filament electrodes e1 and e2. Thereby, the discharge lamp DL starts up, and then the operation of the discharge lamp DL lights up by shifting to an arc discharge. Here, the inductor L1 of the resonance load circuit RLC functions as a current-limiting impedance of the discharge lamp DL. Moreover, in order to carry through the sequence of the preheating, the starting up and the lighting up of the discharge lamp DL, the operation frequency of the inverter circuit INV is controlled in an appropriate manner at each stage.

During operation of the discharge lamp DL, the lamp current detecting circuit I1D of the feedback control circuit FCC detects lamp current, and the first differential amplifier OP1 outputs the feedback control signal corresponding to a difference with the third reference potential source E3, and it continues sending this out to the driving signal generating circuit DSG.

In the driving signal generating circuit DSG. The voltage controlled oscillator VCO whose frequency changes in accordance with the feedback control signal as shown in FIG. 3A. The saw-tooth wave oscillation voltage is applied to the second differential amplifier OP2, and then compared with the first reference potential source E1 or the second reference potential. Thereby, the original driving signal Vg1 or Vg2 partakes the on-duty “a” or the on-duty “1-a”. The original driving signal Vg1 partaking the on-duty “a” as shown in FIG. 3B appears for the first period T1. On the other hand, the original driving signal Vg2 partaking the on-duty “1-a” as shown in FIG. 3C appears for the second period T1. The original driving signals Vg1 and Vg2 respectively appearing for the first period T1 and the second period T2 are applied to the drive circuit GDC. Thereby, the driving signal Vgh for driving the switching device Q1 as shown in FIG. 3E and the driving signal Vgl for driving the switching device Q2 as shown in FIG. 3D are derived.

It is shown that the driving signals Vgh and Vgl have the relation that changes alternately in the first period T1 and the second period T2 as for FIG. 4A. Moreover, FIG. 4B shows the lamp current I1 that changes and flows in the first period T1 and the second period T2.

The on-duty of the driving signal Vgh in the first period T1 is relatively large, while the on-duty of the driving signal Vgl in the same period T1 is relatively small. Therefore, as shown in FIG. 4B, a positive DC current is superposed on the lamp current I1 in the first period T1. Therefore, the operation state of the inverter circuit INV in the first period T1 takes an asymmetric switching operation.

Next, when the second period T2 comes, the relation of the on-duties of the switching devices Q1 and Q2 will invert from the state in the first period T1. At this time, the switching devices Q1 and Q2 take also an asymmetric switching operation although the relation of the on-duties invert. By this operation, in the second period T2, as shown in FIG. 4B, a negative DC current is superposed on the lamp current I1.

Then, since the first period T1 and the second period T2 are repeated alternately, carrying out the alternate asymmetric switching operation, the inverter circuit INV operates by feedback control, and turns on a discharge lamp DL at a fixed brightness.

Moreover, occurrence of straiation and cataphoresis phenomenon is suppressed by above-mentioned alternate asymmetric switching operation. However, since the second period T2 is longer than the first period T1, and a so-called negative DC current flowing in the opposite direction in the period that combined the first period T1 and the second period T2 is greater than positive DC current, cataphoresis phenomenon becomes easy to occur in compared to modification as described later.

In the embodiment of the present invention, each construction element can be constituted as follows.

DC power supplies may be any of a battery power supply and a rectified DC power supply. Moreover, in the case of the latter, you may be any of smoothed and a non-smoothed DC power supply. Furthermore, the DC-DC converter that becomes a rectified DC power supply from switching regulators, such as a DC chopper, by request is combinable. In this case, while impressing the output voltage of a DC-DC converter to the input terminal of an inverter circuit, the lamp current or lamp power of a discharge lamp can be changed by changing the output voltage of a DC-DC converter.

The inverter circuit may have any circuit construction, whatever it includes at least a pair of switching devices capable of carrying out alternate switching operations with each other. For example, the inverter circuit may be a half bridge inverter, a full bridge inverter, etc.

Moreover, the inverter circuit executes an alternate asymmetric switching operation at the pair of switching devices. That is, the relation between the on-duty “a” of one switching device (however, 0<“a”<1) and the on-duty “1-a” of the switching device of another side is defined by that “a” is not equal to “1-a”, or they are complementarily different from each other. For example, in the pair of switching devices, when the on-duty “a” of one switching device is 0.3, the on-duty “1-a” of the other switching device is 0.7. As long as the value of “a” satisfies 0<“a”<1 excepting 0.5, it may take any value.

However, the preferable range of the relation; “a”/“1-a” between the on-duties “a” and “1-a” varies in accordance with the length of the first and the second periods T1, T2 and an ambient temperature. According to experiments, following results were obtained. That is, when the ratio of both on-duties is 1.2 or more, straiation does not occur in condition that the first and the second periods are 500 micro-seconds or more under room temperature. Therefore, the ratio of both on-duties is preferable to be 1.2 or more. When the ratio of both on-duties is 1.9 or more, when the first and the second periods are 500 micro-seconds or more above zero degree C., straiation does not occur. Therefore, more than the ratio of both on-duties 1.9 is a much more preferable range. When the ratio of both on-duties is 2.4 or more, when the first and the second periods are 100 micro-seconds or more above zero degree C., straiation does not occur. Therefore, the range over the ratio of both on-duties 2.4 is optimal.

Furthermore, in the inverter circuit, the pair of switching devices executes the alternate asymmetric switching operation. That is, a first period that the first period wherein the on-duty of one switching device is “a” and the on-duty of the other switching device is “1-a”, and a second period that the on-duty of former switching device is “1-a”, and the on-duty of the latter switching device is “a” are repeated alternately with each other. Generally, it would be preferable that the first period and the second period are equal to each other, since cataphoresis phenomenon hardly occurs in such a state.

Moreover, the lower limits of the first and the second periods may be longer than a time that a DC current is superposed to the lamp current by the asymmetric operation of the pair of switching devices. While the upper limits thereof may be about a time that human eye does not feel flickering of brightness. In order to superpose DC current on lamp current, two or more cycles of asymmetric outputs of an inverter should just continue. Therefore, the lower limit of the first and the second periods is the time of one or more cycles of an inverter output. Moreover, although switching operation of a switching device was based also on a time human being's individual difference, when the maximum value was 10 ms or less, satisfying the above-mentioned conditions is provided with checked it by experiment. In addition, when operating so that an inverter circuit may output the high-frequency voltage of 40 kHz or more, it is about 1-5 ms suitably.

Although a fluorescent lamp is preferable for a discharge lamp, it is not to any particular type. In addition, in order to execute wave conversion of the rectangle wave outputted from an inverter circuit at a sine wave and to control noise occurring in the operation of the discharge lamp at the same time it makes a discharge lamp easy to put into operation, it is good to connect a resonance load circuit to the output terminal of an inverter circuit preferably, and to connect a discharge lamp to an inverter circuit through a resonance load circuit. Although a series resonance circuit is preferable for a resonance load circuit, when another current-limiting impedance element is connected in series to the discharge lamp, a parallel resonance circuit can also be used.

When the resonance load circuit is a series resonance circuit, the resonance impedance that executes series connection to a discharge lamp and that is connected to an inverter circuit can serve as current-limiting impedance. In addition, in case of using no resonance load circuit, it is possible to use a suitable impedance giving a current limiting function by being connected in series with the discharge lamp, thereby executing a current limiting action.

Now the operation of the discharge lamp lighting apparatus according to the present invention will be explained below.

Since the pair of switching devices will execute switching operations alternately and will execute a DC-AC conversion when the inverter circuit is connected to the DC power supply, and an AC voltage appears on the output terminal, and a discharge lamp is energized by the output of an inverter circuit, start, and executes exchange lighting.

However, since the pair of switching devices in an inverter circuit executes the asymmetric switching operation with the on-duties complementarily different each other, a DC component is superposed on the AC lamp current flowing through the discharge lamp. Thereby, occurrence of straiation is suppressed remarkably. In addition, since the DC component becomes large as the difference of the on-duties becomes large, the difference of the on-duties can be suitably given so that a desired value of the DC component may be superposed.

Moreover, the asymmetric switching operation in the pair of switching devices of the inverter circuit continues for the first period and then turned over in the second period. That is, the first and the second periods are set up in advance so that it they take a predetermined relation between them. In the first period, the on-duty of a first switching device is “a”, and the on-duty of a second witching device is “1-a”. In the second period as reversed, the on-duty of the first switching device becomes “1-a”, and the on-duty of the second switching device becomes “a”. Thereby, the polarity of the DC component superimposed on the AC lamp current becomes contrary to it in the first period, and the polarity of a DC component is reversed.

Then, when the polarity reversals of the above-mentioned DC component are carried out, it will be hard coming to generate cataphoresis phenomenon in a discharge lamp. Therefore, according to the present invention, straiation and cataphoresis phenomenon are suppressed remarkably.

By the way, when the lamp current or lamp power of a discharge lamp is small, it is easy to generate straiation. Then, in this invention, it permits constituting so that above-mentioned alternate asymmetric switching operation may be carried out only when lamp current or lamp power is below a predetermined value, and the alternate asymmetric switching operation may not be carried out at the time of the lamp current or lamp power exceeding a predetermined value. In order to realize the operation, further constructions preferable to used will be recited hereunder.

1. A construction that the discharge lamp lights up with an output of the inverter circuit varying in accordance with the lighting control signal, and the inverter circuit executes the alternate asymmetric switching operation only when the lighting control ratio of the discharge lamp is small. In addition, when a lighting control ratio is 100% when it displays by % and they are all optical lightings (100% lighting) and 0%, it is putting out lights (0% lighting), and when it is a middle value, it means that lighting up at a rate that the figure shows to all optical lightings. Therefore, lighting by numerical small % is meant at the time when a lighting control ratio is small.

2. Another construction that the feedback control of the inverter circuit is carried out by detecting the lamp current of the discharge lamp, and controlling the inverter circuit by feeding back the detected lamp current so as that the lamp current becomes below a predetermined value. And, when the detected lamp current has become below the predetermined value, the inverter circuit and when a detection value is below a predetermined value, it is so constructed that an inverter circuit may execute the alternate asymmetric switching operation. The construction is preferable for the case that the lamp current is changed by changing the output frequency of the inverter circuit.

3. Further construction that the feedback control of the DC power supply voltage is carried out so that the lamp current of 3 discharge lamp may be detected and the detection value may approach a predetermined value, and when a detection value is below a predetermined value, the switching devices of the inverter circuit is made to execute an alternate asymmetrical switching operation. The construction is preferable for the case that the lamp current is changed by controlling the DC power supply voltage of the inverter circuit by using a DC-DC converter such as a DC chopper as the DC power supply.

4. Still further construction that the feedback control of the inverter circuit is carried out so that the lamp power of the discharge lamp may be detected and the detection value may approach a predetermined value, and when a detection value is below a predetermined value, it is so constructed that an inverter circuit may execute the alternate asymmetric switching operation. The construction is preferable for the case that the lamp power is changed by changing the output frequency of the inverter circuit.

5. Still further construction that the feedback control of the DC power supply voltage is carried out so that the lamp power of the discharge lamp may be detected and the detection value may approach a predetermined value, and when a detection value is below a predetermined value, it is so constructed that an inverter circuit may execute the alternate asymmetric switching operation. The construction is preferable for the case that the lamp power is changed by controlling the DC power supply voltage for the inverter circuit by using a DC-DC converter such as a DC chopper as the DC power supply.

Referring now to FIGS. 5 to 10, further embodiments of the discharge lamp lighting apparatus according to the present invention will be explained below. In addition, in each figure, the same sign is attached about the same portion as FIGS. 1 to 4, and explanation is omitted.

FIGS. 5A and 5B are a voltage wave for explaining the alternate asymmetric switching operation in the modification of the first embodiment of the discharge lamp lighting apparatus according to the present invention, or a current wave form diagram.

In this modification, since the DC currents that flows forwardly and inversely in the period over the first period T1 and the second period T2, the DC currents are balanced out each other, and thus cataphoresis phenomenon becomes difficult to occur more.

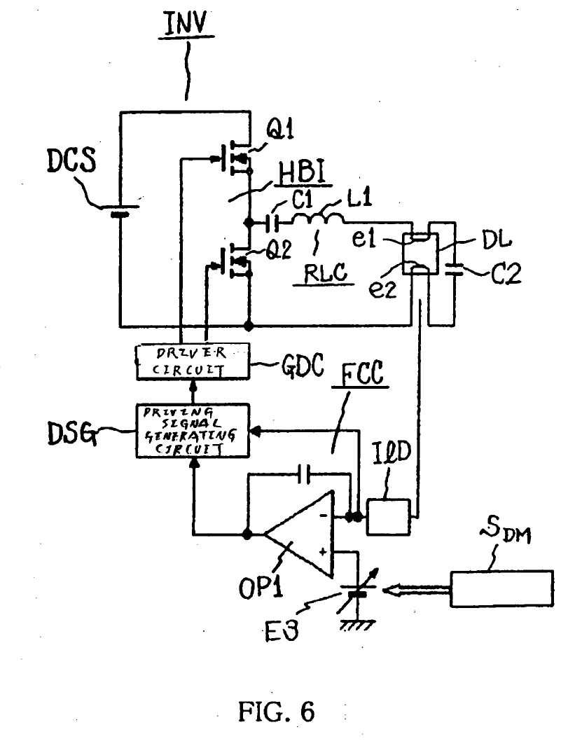

FIG. 6 is a circuit diagram of the whole equipment in that the second embodiment of the discharge lamp lighting apparatus according to the present invention is shown.

In this embodiment, discharge lamp lighting apparatus is so constructed that the lamp current applied to a discharge lamp DL by lighting control signal that comes mainly from the outside may be adjusted. When the lamp current changes, the light output of a discharge lamp DL changes.

In order to realize such operations, operation, it is so constructed that the potential of the third reference potential source E3 of the feedback control circuit FCC may change according to lighting control signal. Therefore, the target value of feedback control changes according to lighting control signal, and since lamp current follows in footsteps and fluctuates in connection with this, lighting control will be carried out. In addition, it is possible to construct that the alternate asymmetric switching operation may be carried out only in the small range of a lighting control ratio.

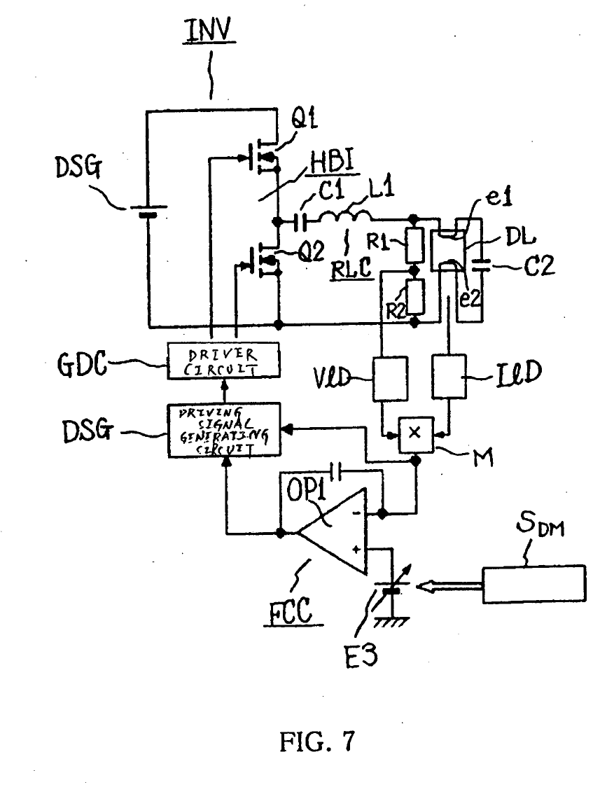

FIG. 7 is a circuit diagram of the whole equipment in that the third embodiment of the discharge lamp lighting apparatus according to the present invention is shown.

In this embodiment, discharge lamp lighting apparatus is so constructed that the lamp power applied to a discharge lamp DL by a lighting control signal that comes mainly from the outside may be adjusted. When the lamp power changes, the light output of the discharge lamp DL changes.

In order to realize such operations, the feedback control circuit FCC may bring lamp power close to target value, in order to realize the above-mentioned operation, the lamp current detecting circuit I1D and the ramp voltage detecting circuit V1D are provided, these detection values are inputted into the multiplication circuit M, and lamp power is found, and it is so constructed that it may be compared with the third reference potential source E3. In addition, the ramp voltage detecting circuit V1D is provided with taken out ramp voltage using voltage dividing circuit formed with resistors R1 and R2 by that multiple connection was carried out to the discharge lamp DL. Others are the same in construction as those in FIG. 6.

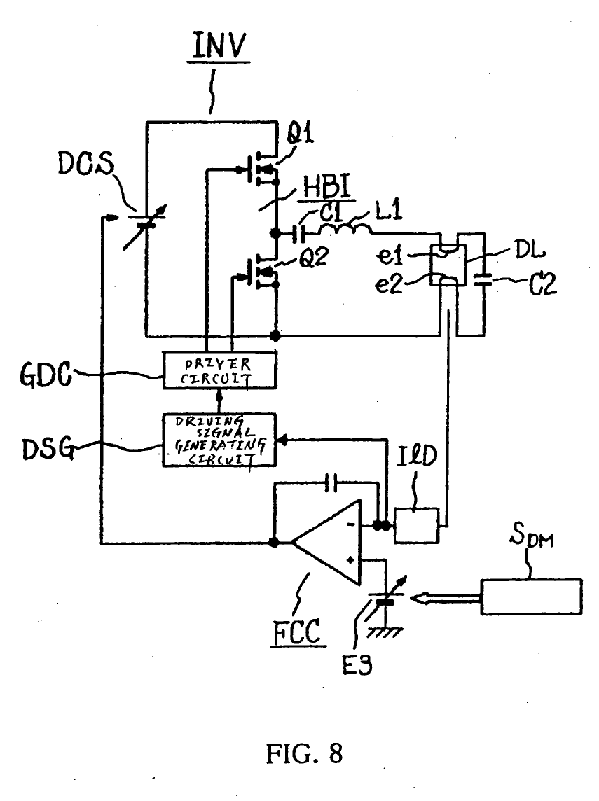

FIG. 8 is a circuit diagram of the whole equipment in that the fourth embodiment of the discharge lamp lighting apparatus according to the present invention is shown.

This embodiment is so constructed that the DC power supply voltage outputted from the DC power supply DCS according to the feedback signal of the lamp current obtained from the feedback control circuit FCC may be adjusted. When the DC power supply voltage changes, the light output of a discharge lamp DL changes. Other construction is the same as that of FIG. 6.

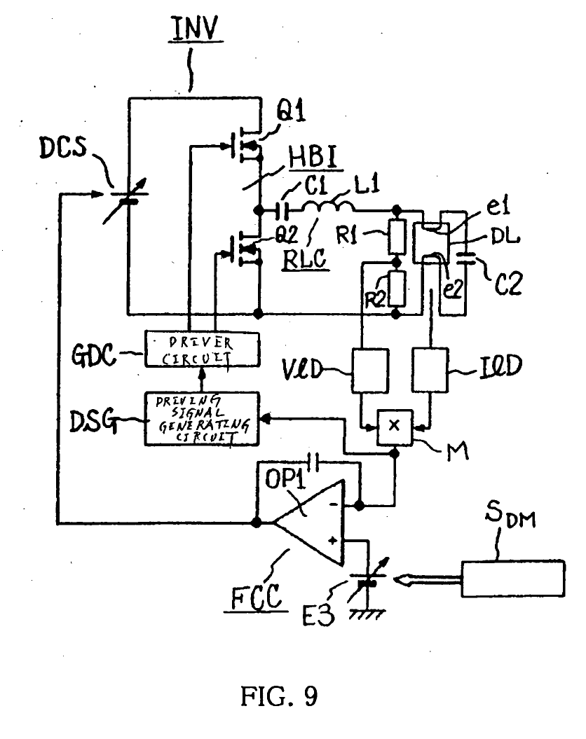

FIG. 9 is a circuit diagram of the whole equipment in that the fifth embodiment of the discharge lamp lighting apparatus according to the present invention is shown.

This embodiment is so constructed that the DC power supply voltage outputted from the DC power supply DCS according to the feedback signal of the lamp power obtained from the feedback control circuit FCC may be adjusted. When the DC power supply voltage changes, the light output of a discharge lamp DL changes. Other construction is the same as that of FIG. 7.

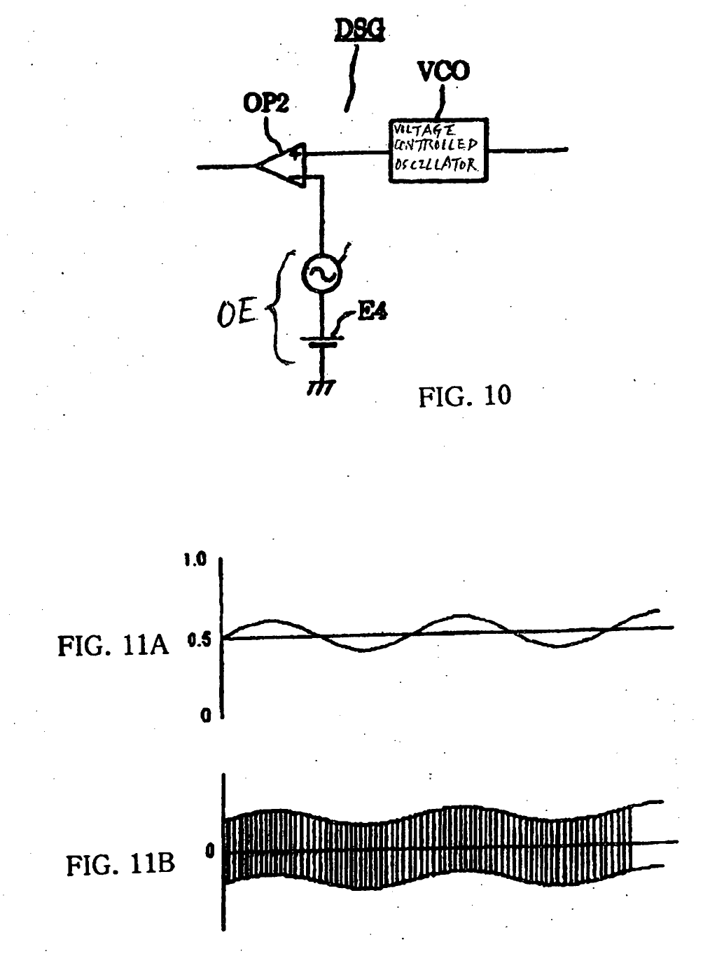

FIGS. 10, 11A and 11B show the 6th embodiment of the discharge lamp lighting apparatus according to the present invention. FIG. 10 is a circuit diagram of a driving signal generating circuit, FIG. 11A is graph showing the temporal change of the on-duty “a”, and FIG. 11B is the wave form diagram of lamp current.

The driving signal generating circuit DSG is provided with the voltage controlled oscillator VCO, the second differential amplifier OP2, and a pulsating reference potential source OE in this embodiment. The voltage controlled oscillator VCO and the second differential amplifier OP2 are the same construction as it in the first embodiment of the discharge lamp lighting apparatus according to the present invention shown in FIG. 2, and circuit operation.

On the other hand, the source OE of rippled type potential is the characteristic component of this embodiment, and is a device to output rippled type reference potential and to input into the inverting input terminal of the second differential amplifier OP2. Moreover, in this embodiment, the pulsating reference potential source OE is comprised of a series circuit of a pulsating potential generator OEG and a constant potential source E4. The pulsating potential generator OEG generates a pulsating potential having a pulsating wave, such as a sinusoidal wave, a triangular wave, a trapezoidal wave that smoothly transfers from the positive half-wave state to the negative half-wave state, and vice versa. The pulsating reference potential source OE generates a fixed DC potential. Therefore, the reference potential that the pulsating reference potential source OE generates turns into DC potential from that the instantaneous value changes to the above-mentioned oscillatory wave form.

The lamp current in this embodiment is a high frequency AC current in which the average of the on-duty in the first period takes “a” while the average of the on-duty in the second period takes “1-a”, and the on-duties changes gradually along the lines the pulsating wave in each of the first and the second periods, as shown in FIG. 11B. Moreover, in addition to this, the envelope curve of the high frequency AC voltage current in lamp current is vibrating synchronizing with the above-mentioned pulsating wave.

Then, as shown in the graph that the on-duty “1-a” of the 180 degrees phase difference shows to FIG. 11A to the on-duty “a” and, according to this embodiment, as a result of changing in the shape of a sinusoidal AC wave form with progress of time, the wave form of the lamp current modulated as a discharge lamp DL lit up and it was shown in FIG. 11B flows. A stress caused in the inverter circuit is reduced at the same time both the straiation and cataphoresis phenomena of a discharge lamp are suppressed, when such lamp current flows.

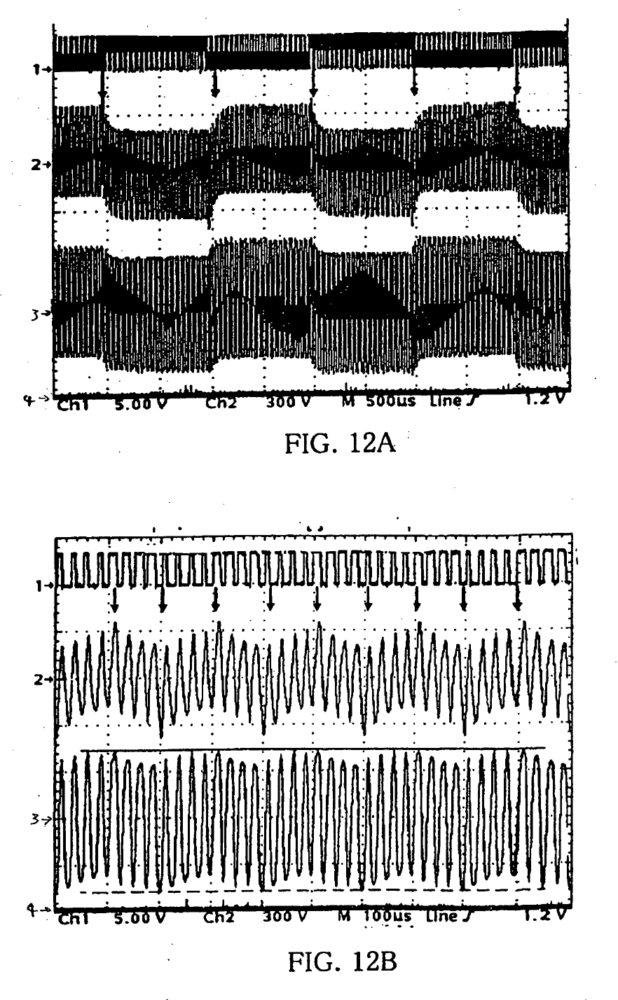

Referring now to FIGS. 12A and 12B, the relation of the first and the second periods relating to carrying out the alternate asymmetric switching operation in the discharge lamp lighting apparatus and the striation according to the present invention will be explained below.

FIGS. 12A and 12B show the discharge lamp lighting apparatus according to the present invention, and the lamp current wave form of the conventional example by comparison. In FIGS. 12A and 12B, the downward-pointing arrows on each graph indicate the turning points between the first period and the second period. In the present invention, a duration of about 0.8 ms in which the peak value of the current being kept constant exists from a transition period of about 100-200 micro-seconds that starts at an instant of turning into the first period or the second period until the operation turns to the second period or the first period, as shown in FIG. 12A. Accordingly, a DC current is superposed on the high frequency current, thereby occurrence of straiation is suppressed. In addition, the first and the second periods are around 1 ms.

On the other hand, since the comparative example is so constructed that the first or the second period changes to the second or the first period in a transitional period that starts at an instance that the first or the second period has changed in the second or the first period, there is no period that the peak value of the current takes a fixed steady state, as shown in FIG. 12B. Thereby, since a DC current fails to be superposed on the high frequency AC current, it becomes difficult to suppress the occurrence of straiation. By the way, the first and the second periods are around 100 micro-seconds.

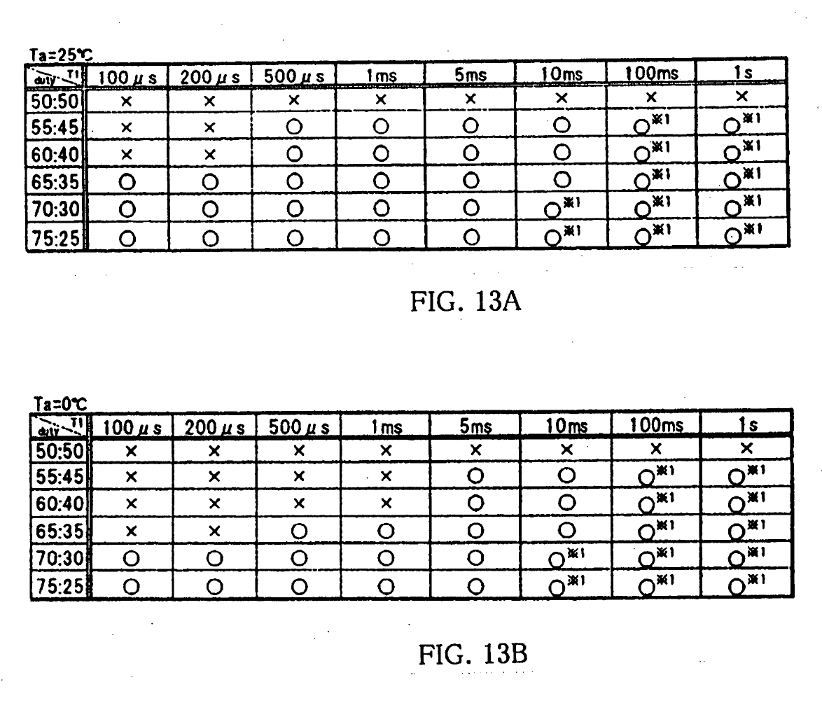

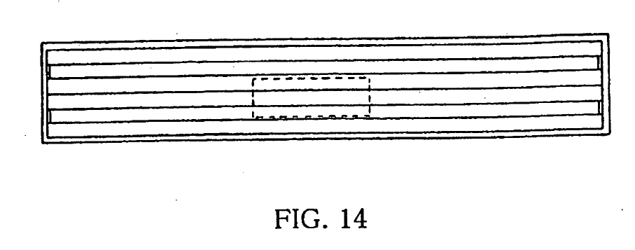

Referring now to FIGS. 13a and 13B, an influence of the first and the second periods and the on-duties of the switching devices on the straiation in the discharge lamp lighting apparatus according to the present invention will be explained hereafter.

FIGS. 13A and 13B show evaluation results of suppressing actions of the discharge lamp lighting apparatus according to the present invention for straiation occurring in the discharge lamp. FIG. 13A is a table showing the evaluation result at an ambient temperature of 25 degrees C. FIG. 13B is a table showing the evaluation result at an ambient temperature of zero degrees C. In the tables of FIGS. 13A and 13B, T1 is the first period, T2 is the second period, and “duty” represents the on-duties “a” and “1-a”, respectively. Moreover, Mark “O” represents “straiation not recognized”, Mark “X” represents “straiation recognized”, and Mark “*” represents “positive column fluctuation recognized”.

As seen from the tables of FIGS. 13A and 13B, according to the present invention, straiation is suppressed for the range of 100 micro-seconds to 10 ms, by the relation of the on-duties being defined in “a” not equal to “1-a”.

FIG. 14 is a bottom view showing a ceiling flush type luminaire according to the present invention which is provided with any discharge lamp lighting apparatus as mentioned above.

The luminaire according to the present invention is characterized by comprising a luminaire chassis, and the discharge lamp lighting apparatus of that the above-mentioned embodiment provided by the luminaire chassis.

This luminaire is a concept containing all pieces of the equipment using luminescence of a discharge lamp. For example, a light, a beacon light, a telltale light, ornament light, etc. correspond. The body of the luminaire is a construction object that accomplishes the base for equipping discharge lamp lighting apparatus, and forms a luminaire conjointly with discharge lamp lighting apparatus.

This luminaire is provided with the luminaire chassis 1, and a discharge lamp lighting apparatus 2. In the discharge lamp lighting apparatus 2, its electric circuit unit is arranged on the back of the luminaire chassis 1, and the discharge lamp DL is arranged on the undersurface of the luminaire chassis 1.

According to the discharge lamp lighting apparatus and the luminaire provided with the discharge lamp lighting apparatus according to the present invention, straiation phenomenon and cataphoresis phenomenon can be commonly suppressed with a very simple construction.

In addition, it cannot be overemphasized that modification implementation is variously possible for this invention in the range that does not deviate not only from the above-mentioned embodiment but from the main point of invention.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

1. A discharge lamp lighting apparatus, comprising:
a DC power supply;
an inverter circuit, connected to the DC power supply, and provided with at least two switching devices; and
a discharge lamp energized by the inverter circuit,
wherein one switching device has an on-duty complementarily different with an on-duty of the other switching device, and
wherein the inverter circuit executes a switching operation in that the on-duty of the one switching device substitutes with the on-duty of the other switching device.

2. A discharge lamp lighting apparatus as claimed in claim 1, wherein
the on-duty of the one switching device substitutes with the on-duty of the other switching device for every predetermined period.

3. A discharge lamp lighting apparatus as claimed in claim 2, wherein the predetermined time comprises a first period and a second period.

4. A discharge lamp lighting apparatus as claimed in claim 3, wherein in the first period, the on-duty of one switching device is “a” (0<“a”<1) and the on-duty of the other switching device is “1-a”, and in the second period, the on-duty of the one switching device is “1-a” and the on-duty of the other switching device is “a”.

5. A discharge lamp lighting apparatus as claimed in claim 4, wherein the switching operation of the inverter circuit is executed at a prescribed low output state of the inverter circuit.

6. A discharge lamp lighting apparatus as claimed in claim 5, wherein the output of the inverter circuit is controlled by a lighting control signal.

7. A discharge lamp lighting apparatus as claimed in claim 6, wherein the predetermined period is 10 ms or less.

8. A discharge lamp lighting apparatus as claimed in claim 7, wherein the on-duty of the one switching device gradually changes to the on-duty of the other switching device at the time that at least the switching operation of the inverter circuit transits from the first period to the second period.

9. Luminaire, comprising:
a luminaire chassis; and
a discharge lamp lighting apparatus as defined in claim 1, which is provided on the luminaire chassis.

10. Luminaire, comprising:
a luminaire chassis; and
a discharge lamp lighting apparatus as defined in claim 2, which is provided on the luminaire chassis.

11. Luminaire, comprising:
a luminaire chassis; and
a discharge lamp lighting apparatus as defined in claim 3, which is provided on the luminaire chassis.

12. Luminaire, comprising:
a luminaire chassis; and
a discharge lamp lighting apparatus as defined in claim 4, which is provided on the luminaire chassis.

13. Luminaire, comprising:
a luminaire chassis; and
a discharge lamp lighting apparatus as defined in claim 5, which is provided on the luminaire chassis.

14. Luminaire, comprising:
a luminaire chassis; and
a discharge lamp lighting apparatus as defined in claim 6, which is provided on the luminaire chassis.

15. Luminaire, comprising:
a luminaire chassis; and
a discharge lamp lighting apparatus as defined in claim 7, which is provided on the luminaire chassis.

16. Luminaire, comprising:
a luminaire chassis; and
a discharge lamp lighting apparatus as defined in claim 8, which is provided on the luminaire chassis.
